(19) United States
(12) Patent Application Publication
(10) Pub. No.: US 2007/0221766 A1
(43) Pub. Date: Sep. 27, 2007

(54) Granulator Mill

(75) Inventors: Henrik Karlsson, Varnamo (SE); Jan Mansson, Varnamo (SE)

Correspondence Address: WRB-IP LLP, 1217 KING STREET, ALEXANDRIA, VA, 22314, US

(73) Assignee: RAPID GRANULATOR AB, Bredaryd (SE)

(21) Appl. No.: 11/570,671

(22) PCT Filed: Jun. 28, 2005
(86) PCT No.: PCT/SE05/01013

§ 371 Date: Dec. 14, 2006

(30) Foreign Application Priority Data
Jul. 8, 2004 (SE) 0401813-1

(51) Int. Cl. B02C 18/14

(52) U.S. Cl. 241/73

(57) ABSTRACT

A granulator mill comprises a mill housing with a rotary knife unit. Beneath the mill housing, a removable granulate box is disposed for accumulating ground material. The mill housing has sections which extend interiorly into the granulate box and seal against its interior surfaces. The granulate box is designed so that it overlaps the mill housing, a gap seal being formed between edge portions of the receptacle box and recesses in the mill housing.

### TECHNICAL FIELD

The present invention relates to a granulator mill which comprises a mill housing in which a rotary knife unit is disposed, and a receptacle box for ground material, the receptacle box being removably secured in the mill housing.

### BACKGROUND ART

Granulator mills of various constructions and sizes are previously known in the art. Small-scale granulator mills, which are easily transported, are generally built on a wheeled chassis. The granulator mill has a mill housing with a rotary knife unit and a number of fixed knives. On the underside of the mill housing, there is a grill or screen which determines particle size of the ground material so that excessively large particles are prevented from entering into a receptacle box for ground material—the granulate box—which is disposed beneath the mill housing.

On the upper side of the mill housing, there is an infeed section or hopper via which the plastic material that is to be ground or granulated is fed in. The infeed hopper is of such a length and height that the interior of the mill housing is inaccessible to the mill operator. The infeed hopper serves a further function, namely to prevent material which is in the process of being ground from being ejected out rearwardly.

The above-mentioned grill or screen that separates the interior of the mill housing from the granulate box guarantees that only particles of a certain maximum size may pass. On the other hand, there is no lower size limit for the particles which pass through the grill. In the grinding process proper, a wide range of particle sizes occurs, ranging from extremely small dust particles up to the maximum particle size that may pass through the grill. This implies that the ground material that arrives in the granulate box also displays a corresponding particle size distribution. In particle the smaller particle fractions may cause severe problems in pollution if they were to get outside the granulate box.

In many prior art mills, it is common practice that the granulate box is suspended in the mill housing on its underside, quite simply in that the mill housing has been provided with sliding beads or strips along which the granulate box is slidable. Such a design and construction does not permit sealing of the interior of the granulate box and naturally entails that quite large quantities of, above all, fine particle fractions “leak out” from the mill housing and the granulate box. Considerable problems involving pollution and fouling occur.

In older prior art mills, it is also common practice that the granulate box is emptied manually, quite simply by lifting down from the mill housing. This also gives rise to considerable inconvenience when the granulate box is emptied, since fine particulate fractions eddy up into the air.

### PROBLEM STRUCTURE

The present invention has for its object to design the granulator mill intimated by way of introduction such that the drawbacks inherent in prior art technology are obviated, in particular problems involving pollution and fouling of the ambient surroundings of the granulator mill. In particular, the present invention has for its object to design the granulator mill so that at a satisfactory sealing is obtained between the mill housing and the granulate box, at the same time as the design and construction are simple and economical in manufacture and easy to serve and operate.

### SOLUTION

The objects forming the basis of the present invention will be attained if the granulator mill intimate by way of introduction is characterised in that the mill housing displays sections which extend interiorly in the receptacle or granulate box and seal against inner surfaces therein.

### BRIEF DESCRIPTION OF THE ACCOMPANYING DRAWINGS

The present invention will now be described in greater detail hereinbelow, with particular reference to the accompanying Drawings. In the accompanying Drawings:

FIG. 1 is a perspective view of a mill housing according to the present invention with a receptacle or granulate box mounted thereon;

FIG. 2 shows, in a view corresponding to that of FIG. 1, the mill housing with a partly open receptacle box;

FIG. 3 is a vertical cross section at right angles to that axis about which the rotary knife unit of the mill housing rotates, the receptacle box being in the closed position;

FIG. 4 is a view corresponding to that of FIG. 3 of the apparatus according to the present invention, the receptacle box being, however, in the partly open position;

FIG. 5 is a vertical cross section at right angles in relation to the sections according to FIGS. 3 and 4 through the axis of rotation of the rotary knife unit disposed in the mill housing;

FIG. 6 is a perspective view corresponding to FIGS. 1 and 2 of the receptacle box;

FIG. 7 is a cross section through an edge portion of the mill housing in a first embodiment;

FIG. 8 is a cross section corresponding to FIG. 7 of a second embodiment; and

FIG. 9 is a cross section corresponding to FIGS. 7 and 8 of a third embodiment.

### DESCRIPTION OF PREFERRED EMBODIMENT

In the following description, positional indications will be employed. These refer to the situation where the granulator mill is located in its normal position of use. In this context, the term “front” relates to that side of the mill which is turned to face towards the mill operator, while the term “rear” relates to that side of the mill which is turned to face away from the mill operator.

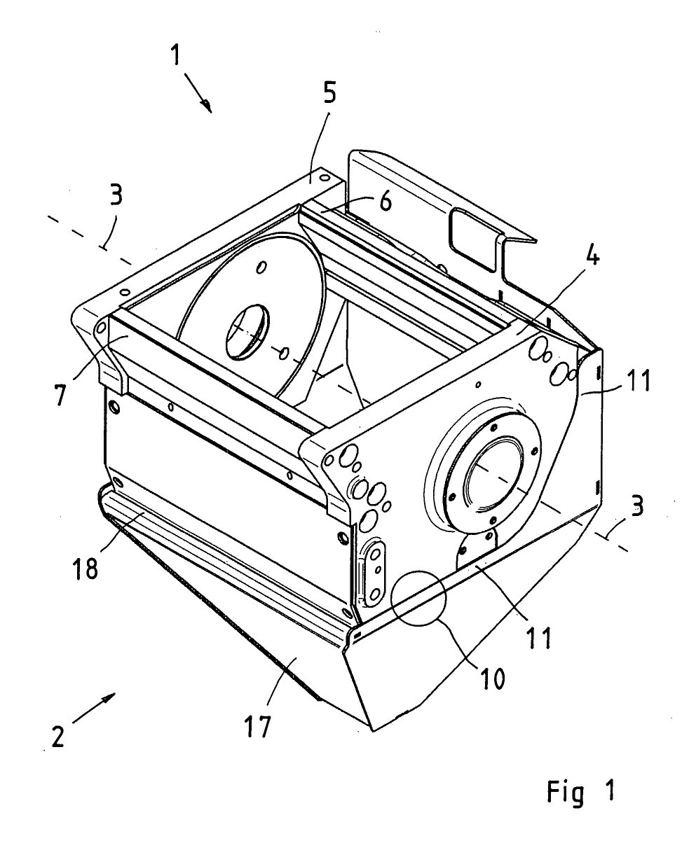

FIG. 1 shows, in perspective seen obliquely from the rear and above, a mill housing 1 on whose underside is removably secured a receptacle box for ground material, a granulate box. For purposes of clarity, the mill housing is shown without the fixed knives disposed therein and the rotary knife unit journalled in the mill housing. However, broken lines 3 intimate the axis of rotation about which the rotary knife unit rotates.

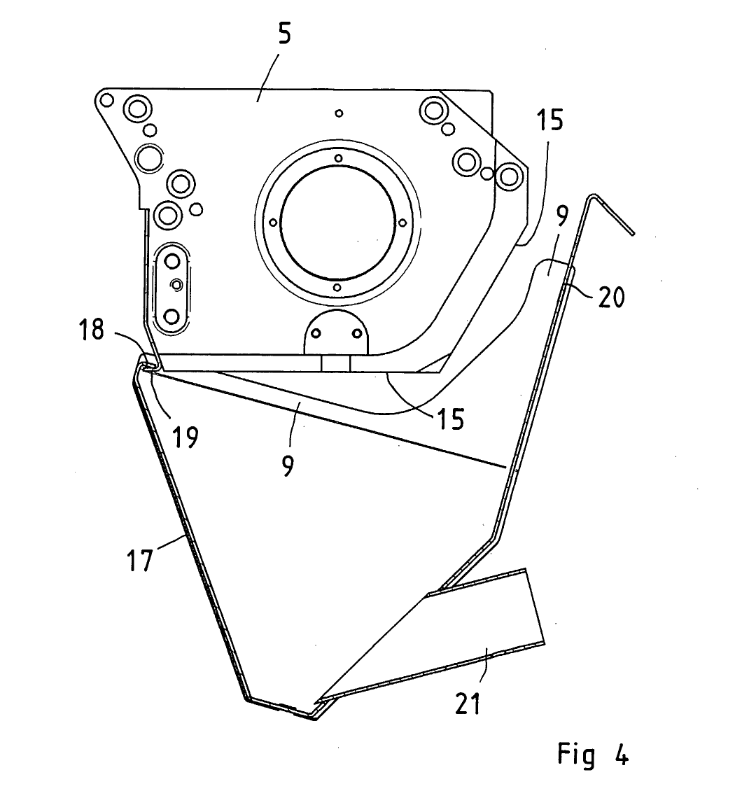

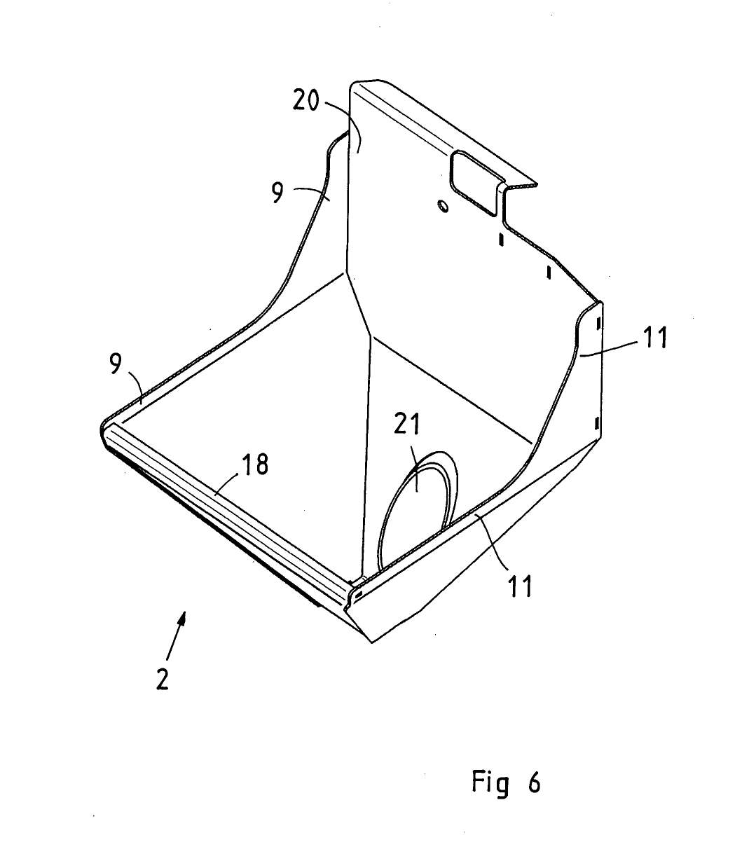

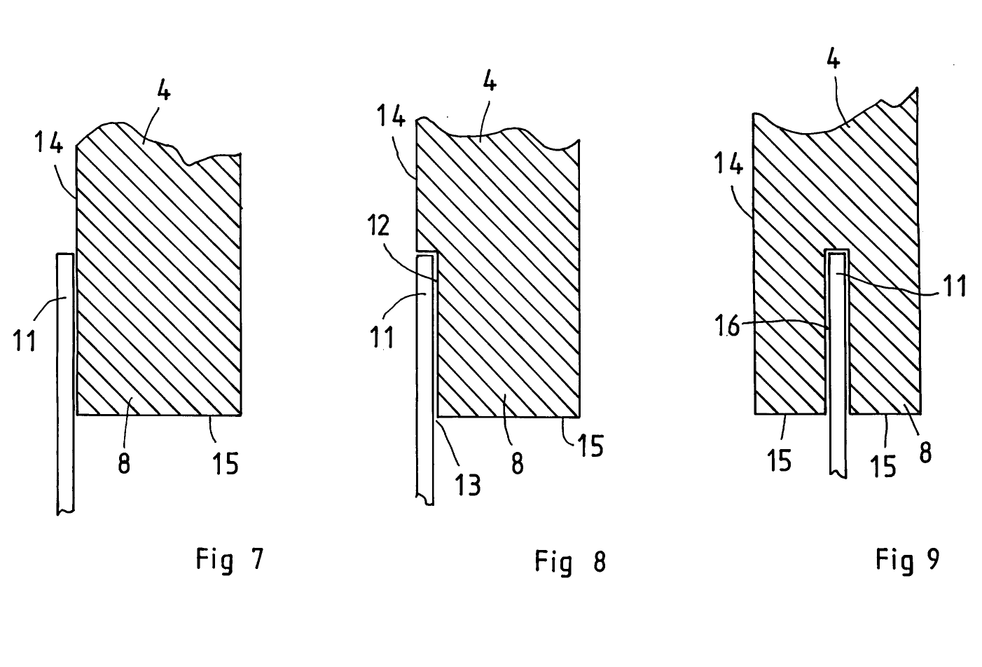

The mill housing 1 has a first end wall 4 and a second end wall 5. The two end walls 4 and 5 are united by the intermediary of a front transverse section 6 and a rear transverse section 7. The end walls have edge surfaces 15 (FIG. 4 and also FIGS. 7 to 9).

In its most generic form, the present invention entails that the mill housing 1 has sections 8 which extend interiorly in the granulate box 2 and seal against inner surfaces 9 therein.

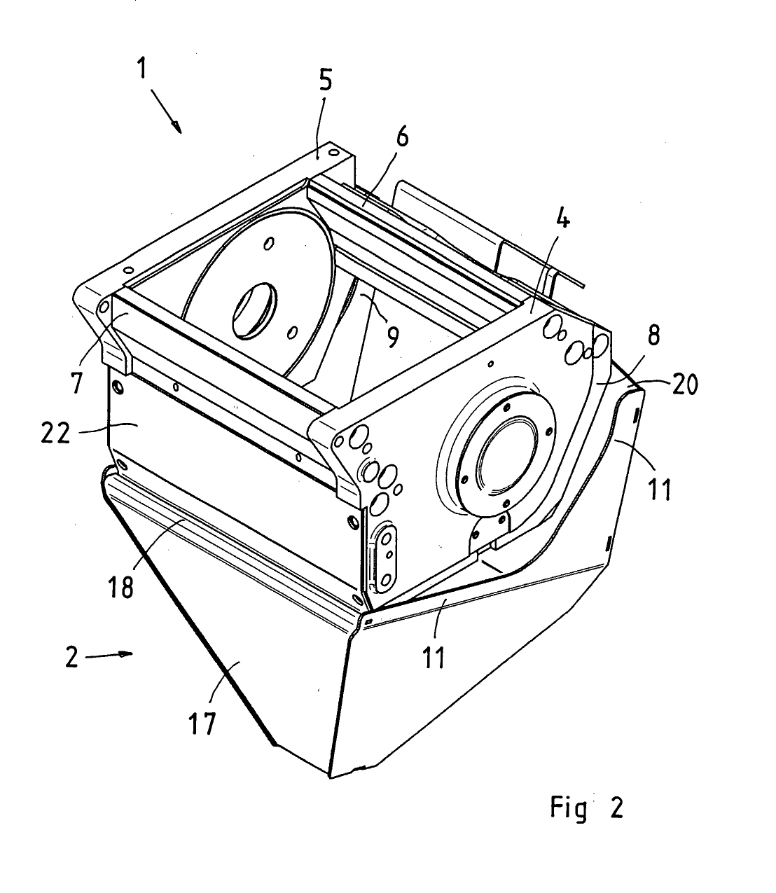

The granulate box 2 has a front wall 20 which, in the closed position of the granulate box (FIGS. 2 and 4), on the one abuts and seals against the outside of the front section 6 and, on the other hand, against upper regions of the edge surfaces 15 of the end walls 4 and 5.

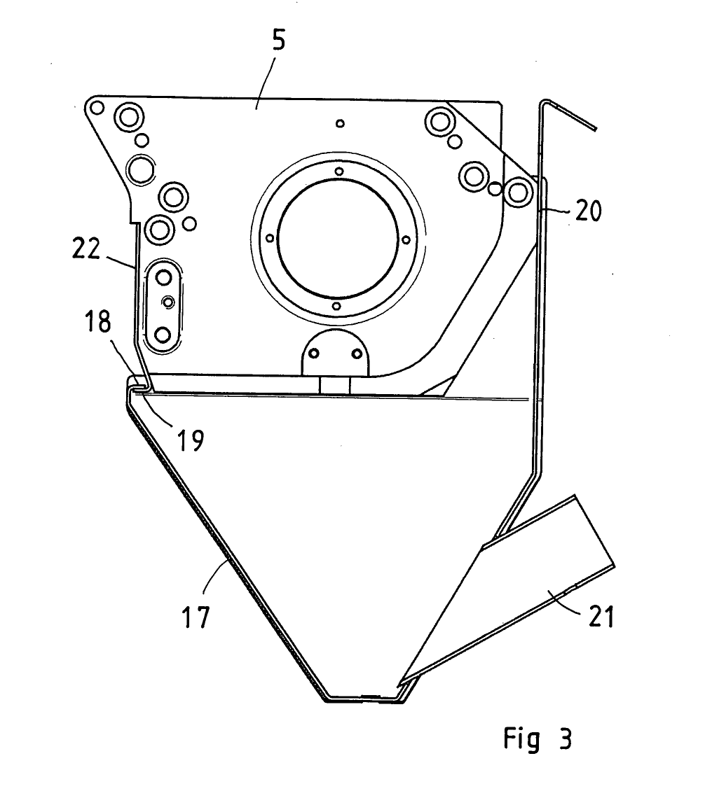

It will further be apparent from FIGS. 3, 4 and 6 that the granulate box 2 has an outlet 21 for connection of an emptying conduit so that emptying by machine may readily be put into effect. As a result, the risk of pollution and fouling caused by manual emptying, when the ground material or granulate is poured out of the granulate box, is avoided.

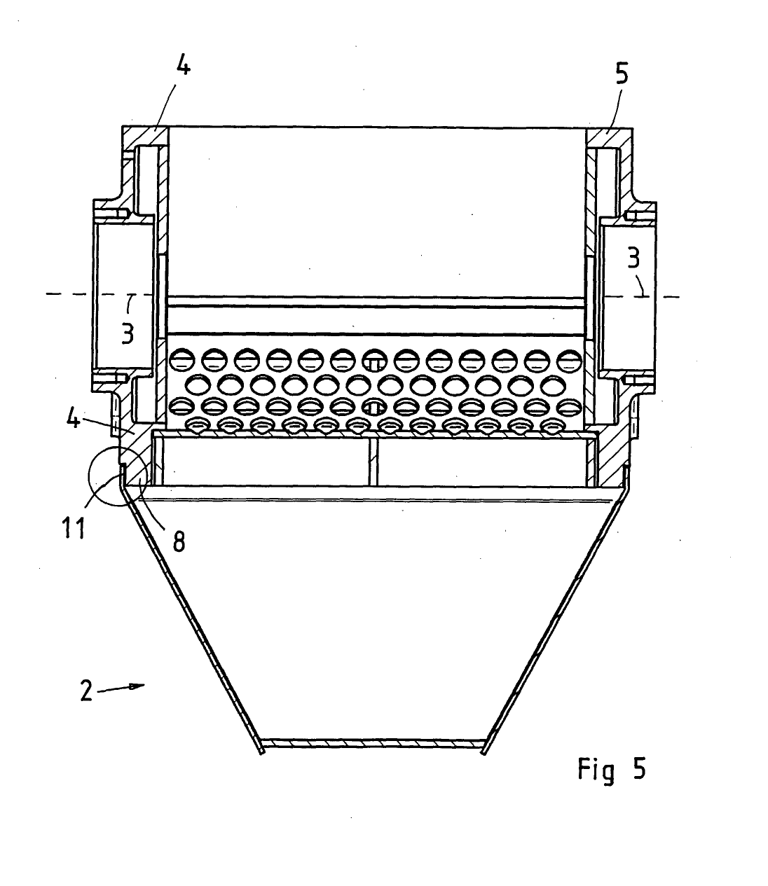

In FIG. 1 a joint area 10 has been marked between the lower edge portion of the first end wall 4 and the sealing edge portion 11 of the granulate box 2. The same area is also marked in FIG. 5 and shown in cross section in FIG. 8. It will be apparent from this Figure that the mill housing 11 and in particular its end walls 4 and 5 at those sections 8 which extend into the granulate box 2, has recesses 12 in which the sealing edge portions 11 of the granulate box are accommodated. The granulate box is thereby formed in such a manner that it straddles, at least partly, the mill housing and in particular its two opposing end walls 4 and 5.

It will be apparent from FIG. 8 that there is a narrow gap between the bottom of the recess 12 and the upper edge portion 11 of the granulate box. Despite the presence of this gap, extremely good sealing will be obtained between the interior of the granulate box and its surroundings, since the seal is of the nature of a gap and/or labyrinth seal. Further, the gap has, at the bottom of the recess 12, its discharge opening 13 located interiorly in the granulate box turned to face downwards, which implies that at least such particles as are transported by force of gravity fall away from the gap.

FIG. 7 shows a simplified variation of the construction according to FIG. 8. In this variation, the recess is absent and instead the edge portion 11 of the granulate box extends up a distance along the outer surface 14 of the end wall 4.

The variation illustrated in FIG. 9 entails that a groove 16 has been provided from the edge surface 15 of the end wall 4 in which the edge portion 11 of the granulate box is accommodated.

For suspending the granulate box 2 on the mill housing 1, but also for sealing along the upper edge of the rear wall 17 of the granulate box, the rear wall has, along its upper edge, an inwardly bent flange 18 which serves the function of sealing- and support surface (see FIGS. 2, 4 and 6). This inwardly bent flange 18 is substantially horizontal in the mounted position of the granulate box 2 and rests on and seals against a corresponding outwardly bent flange 19 along the lower, rear edge of the mill housing. This outwardly bent flange 19 also serves the function of sealing and support surface and is formed in that a rear cover plate 22 which, under the rear transverse section 7, extends between and unites the two end walls 4 and 5, has an outwardly directed bend along its lower edge.

In a comparison between FIGS. 3 and 4, it will be apparent that the granulate box is pivotal about a pivot axis which is defined by the two flanges 18 and 19. For dismounting the granulate box from the position illustrated in FIG. 3, a lock disposed on the front side of the granulate box is first opened, whereafter the granulate box is pivoted to the position illustrated in FIG. 4 where it may simply be slid in a rearward direction so that the flanges 18 and 19 are free from one another.

Mounting of the granulate box 2 on the mill housing 1 takes place in the reverse sequence.

1. A granulator mill which comprises a mill housing in which a rotary knife unit is disposed, and a receptacle box for ground material, the receptacle box being removably secured in the mill housing, wherein the mill housing comprising sections which extend interiorly in the receptacle box and seal against inner surfaces therein.

2. The granulator mill as claimed in claim 1, wherein the receptacle box has edge portions which, for sealing in relation to the mill housing, are accommodated in recesses disposed therein.

3. The granulator mill as claimed in claim 1, wherein the mill housing has opposing end walls in which the rotary knife unit is journalled and the recesses are disposed in the end walls.

4. The granulator mill as claimed in claim 3, wherein the recesses are disposed in the outer sides of the end walls.

5. The granulator mill as claimed in claim 2, wherein the sealing edge portions of the receptacle box straddle the mill housing.

6. The granulator mill as claimed in claim 3, wherein the recesses in the end walls of the mill housing are in the form of grooves in which the sealing edge portions of the receptacle box are accommodated.

7. The granulator mill as claimed in claim 6, wherein the grooves are disposed in edge surfaces of the end walls.

8. The granulator mill as claimed in claim 1, wherein the mill housing has, along a rear, lower edge, a projecting sealing- and support surface, and the receptacle box has a corresponding sealing- and support surface extending in towards an interior of the receptacle box and, for supporting the receptacle box, are positioned on the sealing- and support surface of the mill housing.

9. The granulator mill as claimed in claim 8, wherein the receptacle box is, for insertion and withdrawal of its sealing edge portions into and out of the recesses of the mill housing, respectively, pivotal about a pivot axis which is formed on cooperation between the two sealing- and support surfaces.

10. The granulator mill as claimed in claim 9, wherein the receptacle box has a front defining wall which, in a position of the receptacle box mounted on the mill housing, abuts against edge surfaces on the end walls of the mill housing.

11. The granulator mill as claimed in claim 2, wherein the mill housing has opposing end walls in which the rotary knife unit is journalled and the recesses are disposed in the end walls.

12. The granulator mill as claimed in claim 11, wherein the recesses are disposed in the outer sides of the end walls.

13. The granulator mill as claimed in claim 11, wherein the sealing edge portions of the receptacle box straddle the mill housing.

14. The granulator mill as claimed in claim 11, wherein the recesses in the end walls of the mill housing are in the form of grooves in which the sealing edge portions of the receptacle box are accommodated.

15. The granulator mill as claimed in claim 6, wherein the grooves are disposed in edge surfaces of the end walls.

16. The granulator mill as claimed in claim 2, wherein the mill housing has, along a rear, lower edge, a projecting sealing- and support surface, and the receptacle box has a corresponding sealing- and support surface extending in towards an interior of the receptacle box and, for supporting the receptacle box, are positioned on the sealing- and support surface of the mill housing.

17. The granulator mill as claimed in claim 16, wherein the receptacle box is, for insertion and withdrawal of its sealing edge portions into and out of the recesses of the mill housing, respectively, pivotal about a pivot axis which is formed on cooperation between the two sealing- and support surfaces.

18. The granulator mill as claimed in claim 17, wherein the receptacle box has a front defining wall which, in a position of the receptacle box mounted on the mill housing, abuts against edge surfaces on the end walls of the mill housing.

19. The granulator mill as claimed in claim 3, wherein the receptacle box has a front defining wall which, in a position of the receptacle box mounted on the mill housing, abuts against edge surfaces on the end walls of the mill housing.

20. The granulator mill as claimed in claim 11, wherein the receptacle box has a front defining wall which, in a position of the receptacle box mounted on the mill housing, abuts against edge surfaces on the end walls of the mill housing.
